(19) United States
(12) Patent Application Publication
(10) Pub. No.: US 2026/0084118 A1
(43) Pub. Date: Mar. 26, 2026

(54) NECKLACE-SHAPED NANOFIBER HYBRID MEMBRANE FOR SIMULTANEOUS REMOVAL OF PARTICULATE MATTER AND SULFIDES AND METHOD FOR PREPARING THE SAME

(71) Applicant: GWANGJU INSTITUTE OF SCIENCE AND TECHNOLOGY, Gwangju (KR)

(72) Inventors: Hee Chul CHOI, Gwangju (KR); Min Beom KIM, Gwangju (KR)

(21) Appl. No.: 19/333,277

(22) Filed: Sep. 18, 2025

(30) Foreign Application Priority Data
Sep. 25, 2024 (KR) 10-2024-0129715

(51) Int. Cl. B01D 69/14; B01D 71/02; B01D 71/30; B01D 71/34; B01D 71/42

(52) U.S. Cl. CPC B01D 69/14111; B01D 71/0281; B01D 71/301; B01D 71/34; B01D 71/421; B01D 2323/39

(57) ABSTRACT

A necklace-type nanofiber hybrid membrane is disclosed. ZIF-67 (Zeolite imidazolate framework-67), a type of metal-organic framework (MOF), is formed surrounding surface of the nanofibers to possess a necklace-type structure. The combination of ZIF-67 and nanofibers enables simultaneous removal of fine dust and sulfides while exhibiting excellent stability.

### TECHNICAL FIELD

The present invention relates to a necklace-shaped nanofiber hybrid membrane for simultaneous removal of particulate matter and sulfides, and a method for preparing the same. More specifically, it relates to a nanofiber hybrid membrane having a necklace shape, wherein a zeolite imidazolate framework that is one of the porous metal-organic frameworks grows on electrospun nanofibers doped with Co²⁺, enabling improved filtration efficiency for particulate matter and sulfides.

### BACKGROUND ART

As air pollution becomes severe due to industrialization, the risks and damages caused by various air pollutants such as particulate matter (PM) and harmful gases have emerged as an international problem. Accordingly, issues such as harmful gases generated in industrial field or from indoor volatile organic compounds (VOCs), and the influence on personal health due to indoor and outdoor air quality, need to be addressed. Therefore, filter material capable of controlling fine dust and various gaseous pollutants are being developed.

Zeolite imidazolate framework (ZIF) which is a type of metal-organic framework (MOF) gaining attention as a harmful gas adsorption material, has excellent adsorption performance, high thermal stability, and chemical stability, making it suitable for capturing gaseous pollutants like sulfides. Therefore, it was anticipated that combining MOFs with electrospun nanofibers (ESNF), which possess high porosity and effective surface area, could simultaneously remove PM and gaseous pollutants. However, most MOF crystals tend to agglomerate or separate within the nanofibers, resulting in suboptimal removal performance for gaseous pollutants. Furthermore, inserting MOFs onto nanofibers can affect the structural properties of the nanofibers, potentially hindering the simultaneous removal of PM and gaseous pollutants.

Therefore, there is a need to develop nanofibers containing MOF particles that can simultaneously remove PM and gaseous pollutants including sulfides, while maintaining a stable form.

### DISCLOSURE

### Technical Problem

The first technical objective of the present invention is to provide a necklace-type nanofiber hybrid membrane capable of simultaneously removing fine dust and sulfides.

The second technical objective of the present invention is to provide a manufacturing method for a necklace-type nanofiber hybrid membrane capable of simultaneously removing fine dust and sulfides to achieve the first technical objective.

### Technical Solution

To achieve the aforementioned first technical objective, the present invention provides a necklace-type nanofiber hybrid membrane capable of simultaneously removing fine dust and sulfides. The necklace-type nanofiber hybrid membrane has a structure wherein ZIF-67 crystallites are formed in a necklace structure on polyvinylidene fluoride (PVDF) electrospun nanofibers doped with Co²⁺.

To achieve the second technical objective described above, the present invention provides a method for manufacturing a necklace-type nanofiber hybrid membrane capable of simultaneously removing fine dust and sulfides. The necklace-type nanofiber hybrid membrane is manufactured by electrospinning a polymer solution containing Co²⁺ cations onto a substrate to produce electrospun nanofibers doped with Co²⁺. The ZIF-67 crystallites are then formed on the electrospun nanofibers by introducing the electrospun nanofibers and a mixed solution containing metal ions and Cetyltrimethylammonium bromide (CTAB) into a 2-MIM (2-methylimidazole) solution and leaving the mixture of electrospun nanofibers, mixed solution and 2-MIM solution.

### Advantageous Effects

According to the present invention, ZIF-67 crystals are formed in a necklace-type structure on the electrospun nanofibers doped with Co²⁺, so that excellent chemical stability, long-term reliable performance for air pollution and high adsorption capacity for SO₂ are acquired. Furthermore, it can simultaneously remove particulate matter (PM) and gaseous pollutants like SO₂, and exhibits excellent filtration performance under various humidity conditions.

Furthermore, the necklace-type nanofiber hybrid membrane exhibits excellent hierarchical pore characteristics encompassing micro, meso, and macro pores, while the ZIF-67 crystallites are stably bonded to the nanofibers, imparting exceptional stability. Furthermore, when the nanofiber diameter is 70 nm, ZIF-67 exhibits uniform distribution, causing no structural obstruction to the flow of air or gas molecules. This allows effective exposure to PM and sulfide gases, thereby enhancing air filtration performance.

### DESCRIPTION OF THE DRAWINGS

FIG. 1 is a diagram illustrating the manufacturing method of the necklace-type nanofiber hybrid membrane according to a preferred embodiment of the present invention.

FIG. 2A to 2F are SEM (Scanning Electron Microscope) images according to a preferred embodiment of the present invention.

FIGS. 3A and 3B are TEM (Transmission Electron Microscope) images and EDS (Energy-dispersive X-ray spectroscopy) mapping analysis images according to a preferred embodiment of the present invention.

FIG. 4 is an image showing the bending strength measured according to a preferred embodiment of the present invention.

FIG. 5A to 5F are SEM images comparing the crystal size of ZIF-67 (Zeolite imidazolate framework-67) according to the CTAB (Cetyltrimethylammonium bromide) dosage, based on a preferred embodiment of the present invention.

FIGS. 6A and 6B are XRD (X-ray diffraction) pattern and FT-IR (Fourier-transform infrared spectroscopy) spectrum according to a preferred embodiment of the present invention.

FIG. 7A to 7D are SEM images before and after ultrasonication according to a preferred embodiment of the present invention.

FIG. 8 is TGA (Thermogravimetric analysis) plot according to a preferred embodiment of the present invention.

FIG. 9 is DTGA curve according to a preferred embodiment of the present invention.

FIGS. 10A and 10B are N₂ adsorption-desorption isotherm graphs according to a preferred embodiment of the present invention.

FIGS. 11A and 11B are graphs showing pore size distribution according to a preferred embodiment of the present invention.

FIG. 12 is graph showing the N₂ permeability according to a preferred embodiment of the present invention.

FIG. 13 is graph showing a macro pore diameter distribution according to a preferred embodiment of the present invention.

FIGS. 14A and 14B are graphs measuring the PM (Particulate Matter) filtration efficiency according to a preferred embodiment of the present invention.

FIG. 15A to 15F are graphs measuring the SO₂ adsorption performance according to a preferred embodiment of the present invention.

### MODE OF THE INVENTION

Hereinafter, embodiments of the present invention will be described in detail with reference to the accompanying drawings.

While the present invention is susceptible to various modifications and alternative forms, specific embodiments thereof are shown by way of example in the drawings and will herein be described in detail. However, it should be understood that there is no intent to limit the invention to the particular forms disclosed but rather the invention is to cover all modifications, equivalents, and alternatives falling within the spirit and scope of the invention defined by the appended claims.

When an element such as a layer, a region, and a substrate is referred to as being disposed “on” another element, it should be understood that the element may be directly formed on the other element or an intervening element may be interposed therebetween.

It should be understood that, although the terms “first,” “second,” etc. may be used herein to describe various elements, components, areas, layers, and/or regions, these elements, components, areas, layers, and/or regions are not limited by these terms.

### EMBODIMENT

The present invention provides a necklace-type nanofiber hybrid membrane capable of simultaneously removing fine dust and sulfides.

The necklace-type nanofiber hybrid membrane comprises electrospun nanofibers doped with Co²⁺ and a ZIF-67 (Zeolite imidazolate framework-67) crystallites formed in a necklace shape surrounding the electrospun nanofibers.

The electrospun nanofibers preferably have an average diameter of 60 nm to 70 nm without bead defects. When the electrospun nanofibers are produced without bead defects within the average diameter range of 60 nm to 70 nm, uniform deposition across the nanofiber layers is possible. Furthermore, an interconnected macroporous nano structure can form among the nanofibers, enabling smooth air flow and low pressure drop during air permeation, and facilitating efficient binding with fine dust or SO₂.

The ZIF-67 crystallites may have an average diameter of 250 nm to 1,200 nm, with 300 nm to 450 nm being more desirable. If the average diameter of the ZIF-67 crystallites is less than 250 nm, it may be difficult to form a stable necklace-type structure on electrospun nanofibers with an average diameter of 60 nm to 70 nm. Furthermore, due to the non-uniformly dispersed ZIF-67 crystallites, binding with fine dust or SO₂ may be difficult. Conversely, if the average diameter of the ZIF-67 crystallites exceeds 1,200 nm, the pores within the structure where electrospun nanofibers and ZIF-67 crystallites coexist may not form sufficient hierarchical pores to adsorb fine dust or SO₂.

The diameter of the ZIF-67 crystallites can be controlled by the amount of CTAB (Cetyltrimethylammonium bromide) introduced during the formation process of the ZIF-67 crystallites. CTAB can slow the growth of ZIF-67 crystallites by interacting with metal ions in the solution during crystallite growth. Therefore, the diameter of ZIF-67 can be controlled by adjusting the CTAB input amount during crystallite formation and necklace-type nanofiber hybrid membrane suited for specific applications can be easily manufactured.

It is desirable to introduce CTAB at a concentration of 0.003 mol/L to 0.3 mol/L, more desirable at 0.01 mol/L to 0.1 mol/L, and most desirable at 0.01 mol/L to 0.05 mol/L. When CTAB is introduced at 0.003 mol/L to 0.3 mol/L, ZIF-67 crystal grain growth can be enhanced by the Oswald ripening. Furthermore, when CTAB is introduced at 0.01 mol/L to 0.05 mol/L, the uniformity of the ZIF-67 crystallites formed on the nanofibers can be further improved.

The above necklace-type nanofiber hybrid membrane can capture PM0.3 (particulate matter of 0.3 μm size) or larger at a rate of 97% or higher, achieving a high fine dust removal efficiency.

The above necklace-type nanofiber hybrid membrane can exhibit high adsorption capacity by adsorbing SO₂ at less than 1476.5 mg/g.

The electrospun nanofibers may be formed by electrospinning a solution using one or more polymers selected from the group consisting of polyacrylonitrile (PAN), polyvinylidene fluoride (PVDF), polyvinyl chloride (PVC), and polyethylene terephthalate (PET). The electrospun nanofibers are preferably made using PVDF, but are not limited thereto.

The present invention provides a method for manufacturing the above-mentioned necklace-type nanofiber hybrid membrane. The manufacturing method is described in more detail below with reference to the drawings.

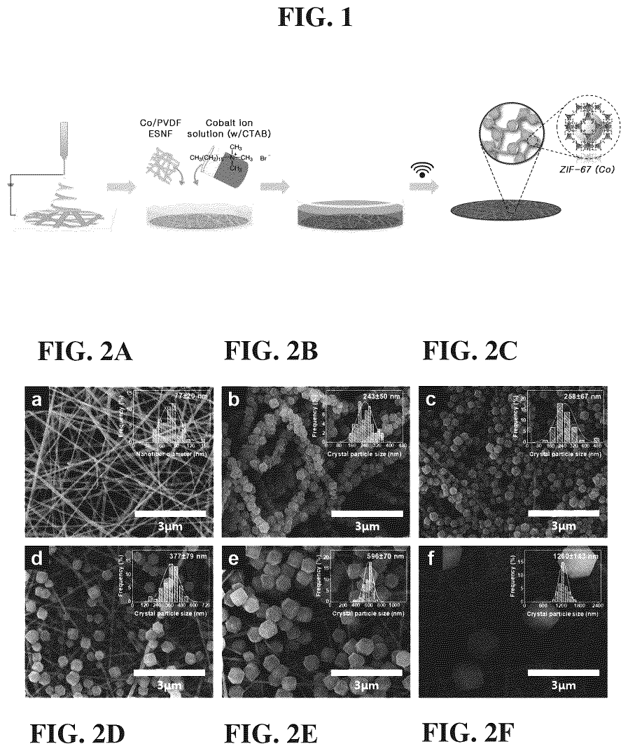

FIG. 1 is a diagram illustrating the manufacturing method of the necklace-type nanofiber hybrid membrane.

Referring to FIG. 1, the necklace-type nanofiber hybrid membrane is manufactured by first step of electrospinning a polymer solution containing Co²⁺ cations onto a substrate to produce electrospun nanofibers doped with Co²⁺, and a second step of introducing manufactured electrospun nanofibers and a mixed solution containing metal ions and CTAB into a 2-MIM (2-Methylimidazole) solution which serves as a ligand, and allowing it to stand to form ZIF-67 crystallites on the electrospun nanofibers.

To enhance the stability of the necklace-type nanofiber hybrid membrane, the process may further include a step of ultrasonically treating the electrospun nanofibers with ZIF-67 crystallites produced through the second step.

Through the ultrasonic treatment, ZIF-67 formed unstably on the electrospun nanofibers and residues of the mixed solution can be removed, enabling the production of a highly stable necklace-type nanofiber hybrid membrane.

In a first step, a polymer solution containing Co²⁺ cations is electrospun onto a substrate to produce electrospun nanofibers doped with Co²⁺.

The polymer solution contains metal ions including Co²⁺ cations. The Co²⁺ cations in the polymer solution can enhance the chemical stability of the electrospun nanofibers and provide active sites during ZIF-67 crystal grain growth, enabling uniform ZIF-67 growth on the nanofibers.

The polymer solution comprises one or more polymers selected from group consisting of polyacrylonitrile (PAN), polyvinylidene fluoride (PVDF), polyvinyl chloride (PVC) and polyethylene terephthalate (PET), and it is more preferable to use PVDF, but is not limited thereto.

The electrospun nanofibers are preferably produced without bead defects and have an average diameter of 60 nm to 70 nm. When the electrospun nanofibers are produced without bead defects within the range of an average diameter of 60 nm to 70 nm, uniform deposition is possible layer by layer of the nanofibers. Furthermore, an interconnected macroporous nano structure can form among the nanofibers, enabling smooth air flow and low pressure drop during air permeation, and facilitating efficient binding with fine dust or SO₂.

In a second step, electrospun nanofibers produced by the first step and a mixed solution containing metal ions and CTAB are introduced into a 2-MIM solution, which serves as a ligand, and left to stand to form ZIF-67 crystallites on the electrospun nanofibers.

The metal ions are preferably selected from the group consisting of Sc, Ti, V, Cr, Mn, Fe, Co, Ni, Cu, Zn, Y, Zr, Nb, Mo, Tc, Ru, Rh, Pd, Cd, La, W, Os, Ir, Pt, Au, Hg, Sm, Eu, Gd, Tb, Dy, Ho, Al, Ga, In, Ge, Sn, Pb, Li, Na, K, Rb, Cs, Mg, Ca, Sr, and Ba, and it is more desirable to include Co.

The ZIF-67 crystallites can be formed by leaving them at room temperature for 0.5 to 2 hours.

The ZIF-67 crystallites may have a rhombohedral structure with various particle sizes.

The ZIF-67 crystallites may have an average diameter of 250 nm to 1,200 nm, and it is more preferable that the average diameter be 300 nm to 450 nm. If the average diameter of the ZIF-67 crystallites is less than 250 nm, it may be difficult to form a stable necklace-type structure on electrospun nanofibers having an average diameter of 60 nm to 70 nm. Furthermore, due to the non-uniformly dispersed ZIF-67 crystallites, it may be difficult to bind with fine dust or SO₂. Conversely, if the average diameter of the ZIF-67 crystallites exceeds 1,200 nm, the pores among structures where electrospun nanofibers and ZIF-67 crystallites coexist may not form sufficient hierarchical pores to adsorb fine dust or SO₂.

The diameter of the ZIF-67 crystallites can be controlled according to the amount of CTAB (Cetyltrimethylammonium bromide) introduced during the formation process of the ZIF-67 crystallites. The CTAB can slow the growth of ZIF-67 crystallites by interacting with metal ions in the solution during crystallite growth. Therefore, the diameter of ZIF-67 is controlled by adjusting the CTAB input amount during its formation, so that the formation of a necklace-type nanofiber hybrid membrane suited for specific applications becomes easier.

It is desirable to introduce CTAB at 0.003 mol/L to 0.3 mol/L, more desirable at 0.01 mol/L to 0.1 mol/L, and most desirable at 0.01 mol/L to 0.05 mol/L. When CTAB is introduced at 0.003 mol/L to 0.3 mol/L, ZIF-67 crystal grain growth can be enhanced by the Oswald ripening. Furthermore, when CTAB is introduced at 0.01 mol/L to 0.05 mol/L, the uniformity of ZIF-67 crystallites formed on the nanofibers can be further improved.

When methanol is used as the solvent in the mixed solution, CTAB can increase the dispersion of Co²⁺ in the mixed solution, thereby enhancing interaction with the 2-MIM solution and promoting the growth of small ZIF-67 crystals.

The electrospun nanofiber hybrid membrane with ZIF-67 crystallites can simultaneously remove PM and SO₂.

The necklace-type nanofiber hybrid membrane can capture PM0.3 (particulate matter of 0.3 μm size) or larger at a rate of 97% or higher, achieving a high fine dust removal efficiency.

The necklace-type nanofiber hybrid membrane can adsorb SO₂ at 1476.5 mg/g or less, demonstrating high adsorption capacity.

### Manufacturing Example 1

PVDF 12 wt %, Co(NO₃)₂·6H₂O 0.5 wt %, and CTAB 0.00175 mol/L were dissolved and stirred in DMSO/acetone (30/70, v/v), then heated at 80° C. for 24 hours to prepare a Co/PVDF solution. The Co/PVDF solution was loaded into a syringe equipped with a stainless steel needle and electrospun onto polyethylene terephthalate (PET) under a high voltage of 16 kV. The PET onto which the Co/PVDF solution was electrospun was thermally rolled at 60° C. to produce Co/PVDF electrospun nanofibers.

### Manufacturing Example 2

The Co/PVDF electrospun nanofibers prepared in Manufacturing Example 1 were immersed in a 2-MIM (2-Methylimidazole) solution. A mixed solution containing Co(NO₃)₂·6H₂O and CTAB 0.003 mol/L was then added. The solution was left at 30° C. for 2 hours to form ZIF-67 crystallites on the nanofibers. The Co/PVDF electrospun nanofibers with ZIF-67 crystallites were washed with methanol and deionized water to remove residual 2-MIM and CTAB, then oven-dried at 40° C. to obtain ZIF-67/PVDF nanofiber hybrid membranes.

### Manufacturing Example 3

A ZIF-67/PVDF nanofiber hybrid membrane was prepared under the same conditions as in Manufacturing Example 2, except that the CTAB concentration was 0.01 mol/L.

### Manufacturing Example 4

A ZIF-67/PDVF nanofiber hybrid membrane was prepared under the same conditions as in Manufacturing Example 2, except that the CTAB concentration was 0.03 mol/L.

### Manufacturing Example 5

Under the conditions of the above Manufacturing Example 2, except that the CTAB concentration was 0.1 mol/L, a ZIF-67/PVDF nanofiber hybrid membrane was prepared under same conditions.

### Manufacturing Example 6

A ZIF-67/PDVF nanofiber hybrid membrane was prepared under the same conditions as in Manufacturing Example 2, except that the CTAB concentration was 0.3 mol/L.

### Measurement Example 1

SEM and TEM images are measured to confirm the formation of ZIF-67 crystallites on the nanofibers, resulting in a necklace-type nanofiber hybrid membrane structure.

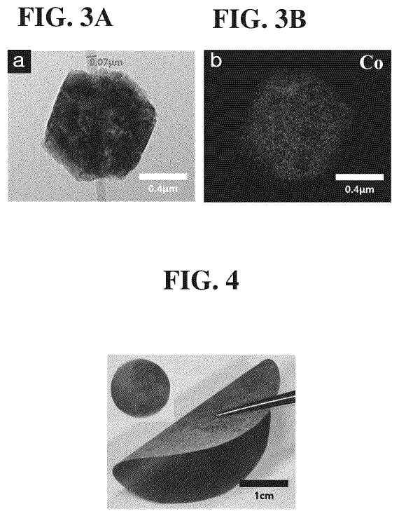

FIG. 2 is SEM (Scanning Electron Microscope) images of Manufacturing Examples 1 to 6 according to preferred embodiments of the present invention, and FIG. 3 is TEM (Transmission Electron Microscope) images and EDS (Energy Dispersive X-ray Spectroscopy) mapping analysis images.

Referring to FIGS. 2 and 3, FIG. 2A shows the electrospun nanofibers of Manufacturing Example 1 without ZIF-67 crystallites. The electrospun nanofibers of the Manufacturing Example 1 have an average diameter of 70 nm or less. Since no bead defects occur, the electrospun nanofibers exhibit a uniformly smooth, interconnected, macroporous nanofiber structure formed by continuous layer-by-layer deposition. FIGS. 2B to 2F are SEM images of Manufacturing Examples 2 to 6, showing that larger ZIF-67 crystals with increased average diameter formed as the CTAB loading increased. This demonstrates that CTAB loading influences ZIF-67 crystal grain size.

FIG. 3A is a TEM image showing the ZIF-67 crystallite structure surrounding the electrospun nanofibers of Manufacturing Example 4. It reveals that ZIF-67 crystallite is formed on the nanofibers in a necklace-type or bead-type morphology. FIG. 3B shows EDS mapping of the ZIF-67 crystallite structure of Manufacturing Example 4 to confirm the Co dispersion in the necklace-type nanofiber hybrid membrane. It confirms that Co is uniformly observed on the surface of ZIF-67.

Therefore, FIG. 3 demonstrates that ZIF-67 grows uniformly on the electrospun nanofibers.

FIG. 4 shows the bending strength measurement results for Manufacturing Example 4. Referring to FIG. 4, it is confirmed that the necklace-type nanofiber hybrid membrane exhibits excellent flexibility bending beyond 90°.

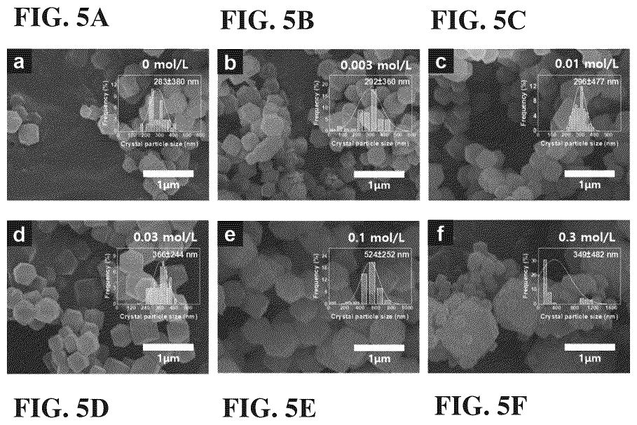

FIGS. 5A-5F are SEM images of Manufacturing Examples 2 to 6. Referring to FIGS. 5A-5F, it is observed that the diameter of ZIF-67 crystallites increased with the amount of CTAB (Cetyltrimethylammonium bromide) added. FIG. 5A shows nanofiber membrane manufactured according to Manufacturing Example 1, and FIG. 5B shows nanofiber hybrid membrane manufactured according to Manufacturing Example 2. Furthermore, FIG. 5C shows nanofiber hybrid membrane manufactured according to Manufacturing Example 3, FIG. 5D shows nanofiber hybrid membrane manufactured according to Manufacturing Example 4, FIG. 5E) shows nanofiber hybrid membrane manufactured according to Manufacturing Example 5, and FIG. 5F shows nanofiber hybrid membrane manufactured according to Manufacturing Example 6.

From FIG. 5A to FIG. 5E, it is confirmed that the size of ZIF-67 crystallite increases as the amount of CATB added increases from 0 mol/L to 0.1 mol/L. However, in the product of Manufacturing Example 6, where CATB was added at a concentration of 0.3 mol/L, it is confirmed that secondary crystal grains formed on the surface of the large-sized ZIF-67 crystallite.

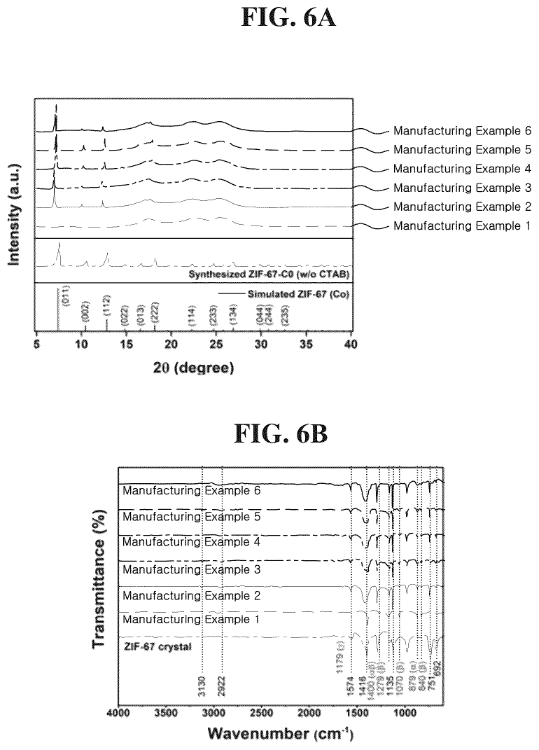

FIG. 6 is the XRD (X-ray diffraction) patterns and FT-IR (Fourier-transform infrared spectroscopy) spectra for Manufacturing Examples 1 to 6.

Referring to FIGS. 6A and 6B, in FIG. 6A, nanofiber hybrid membranes of Manufacturing Examples 2 to 6 exhibit XRD peak positions similar to those of ZIF-67-CO synthesized without CTAB and simulated ZIF-67 sample. This indicates that ZIF-67 crystallites are successfully formed on the nanofibers in Manufacturing Examples 2 to 6.

FIG. 6B shows that peaks of nanofiber hybrid membranes of Manufacturing Examples 2 to 6 are observed at the same positions as the ZIF-67 crystal. The peaks between 600 cm⁻¹ and 1,500 cm⁻¹ may be attributed to stretching and bending of the imidazole ring. Furthermore, the peak at 1,580 cm⁻¹ may have been formed by the stretching of the C═N double bond in 2-MIM, while the peaks at 2,920 cm⁻¹ and 3,135 cm⁻¹ may correspond to the stretching modes of the C—H single bonds in the aromatic ring and aliphatic chain of 2-MIM, respectively. Furthermore, peaks corresponding to the crystalline forms of the α, β, and aromatic β phases of PVDF nanofibers are observed in nanofiber hybrid membranes of Manufacturing Examples 2 to 6, confirming the bonding between the electrospun nanofibers and the ZIF-67 crystallites.

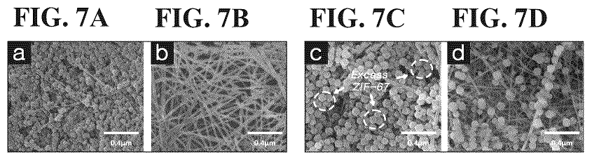

FIG. 7A-FIG. 7D are SEM images of Manufacturing Examples 1 and 4 before and after ultrasonic treatment.

Referring to FIG. 7A-FIG. 7D, image FIG. 7A shows nanofiber membrane of Manufacturing Example 1, and FIG. 7B shows that the ZIF-67 crystallites formed on the electrospun nanofibers are almost completely detached after ultrasonic treatment for nanofiber membrane of FIG. 7A. In contrast, FIG. 7C shows nanofiber hybrid membrane of Manufacturing Example 4, and FIG. 7D shows that ZIF-67 crystals except for a few over-crystallized particles are remained stably bonded to the electrospun nanofibers even after ultrasonic treatment for nanofiber hybrid membrane of FIG. 7C. Therefore, it can be concluded that when CTAB is introduced during ZIF-67 crystal formation, the necklace-type nanofiber hybrid membrane has ultra-stability.

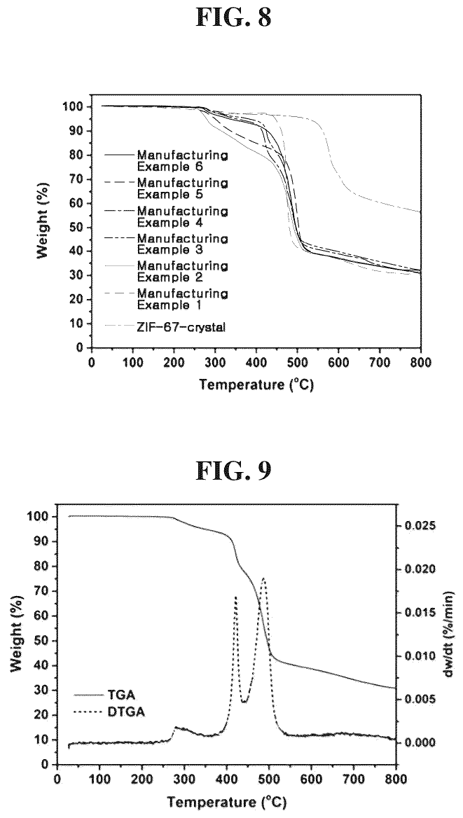

FIG. 8 is a TGA (Thermogravimetric Analysis) plot according to a preferred embodiment of the present invention.

Referring to FIG. 8, the initial weight loss occurs through the release of low molecules such as solvents and water below 30° C., followed by subsequent weight loss between 400° C. and 500° C. due to the decomposition of PVDF nanofibers. Furthermore, the weight loss occurring between 500° C. and 600° C. may be due to the decomposition of ZIF-67. In Manufacturing Examples 2 to 6, the size of ZIF-67 crystallites varies depending on the amount of CTAB added, but the bulk content of ZIF-67 crystallites on the electrospun nanofibers remained constant. For more specific quantification, weight loss of Manufacturing Example 4 is shown in FIG. 9.

### Measuring Example 2

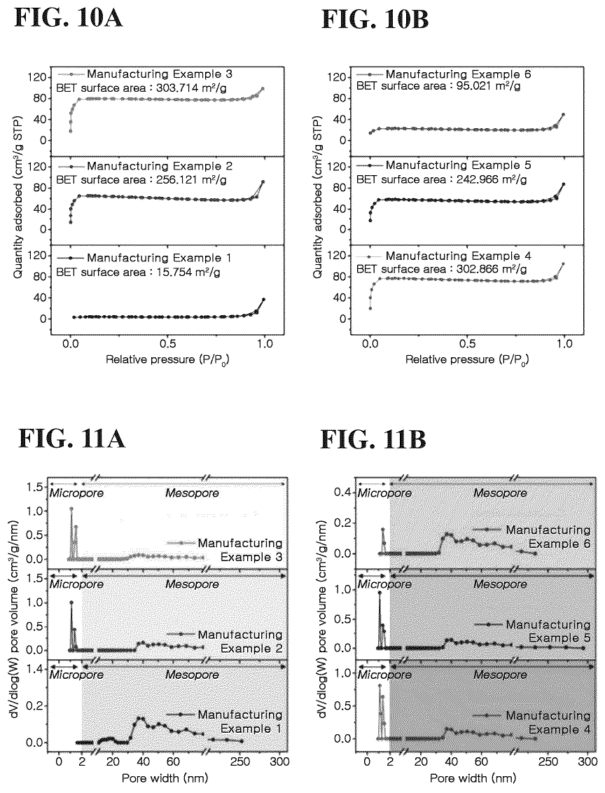

FIGS. 10 to 13 are graphs measuring the hierarchical pore structure and pore characteristics.

FIG. 10A and FIG. 10B shows the N₂ adsorption-desorption isotherm graphs obtained at 77K for Manufacturing Examples 1 to 6. FIG. 11A and FIG. 11B shows graphs representing the micro- and mesopore size distributions. The values calculated from the results obtained from FIGS. 10 and 11 are shown in Table 1 below.

Referring to FIGS. 10 and 11, and Table 1, the BET surface area of nanofiber membrane of Manufacturing Example 1, which did not contain CTAB during ZIF-67 crystal grain formation, is 15.754 m²/g. In contrast, nanofiber hybrid membranes of Manufacturing Examples 2 to 6 exhibit higher BET surface areas, with Manufacturing Example 3 having the most favorable value of 303.714 m²/g.

In FIG. 11A and FIG. 11B, the pore volume value for the nanofiber membrane of Manufacturing Example 1 is 0.057 cm³/g, whereas nanofiber hybrid membranes of Manufacturing Examples 2 through 6 exhibit higher pore volume values compared to Manufacturing Example 1. Nanofiber hybrid membrane of Manufacturing Example 4 has the highest pore volume value at 0.162 cm³/g. Therefore, it can be seen that adding CTAB during ZIF-67 crystal grain formation increases the microporosity, thereby improving the pore volume value. However, excessive CTAB addition can increase ZIF-67 crystal grain size. If ZIF-67 crystal grains agglomerate, the pore volume and BET surface area may decrease. Therefore, nanofiber hybrid membranes of Examples 3 and 4, which exhibit optimal measured pores and minimal particle agglomeration, are desirable for necklace-type nanofiber hybrid membranes.

TABLE 1

| | | Langmuir | External | Pore | Average |
|---|---|---|---|---|---|
| | BET surface | surface area | surface area | volume | diameter of |
| | area (m²/g) | (m²/g) | (m²/g) | (cm³/g) | pore (Å) |
| Manufacturing Example 1 | 15.754 | 17.648 | 5.851 | 0.057 | 1789.594 |
| Manufacturing Example 2 | 256.121 | 277.357 | 21.036 | 0.142 | 9.285 |
| Manufacturing Example 3 | 303.714 | 343.824 | 28.232 | 0.153 | 7.906 |
| Manufacturing Example 4 | 302.866 | 336.487 | 23.553 | 0.162 | 9.195 |
| Manufacturing Example 5 | 242.968 | 253.730 | 20.432 | 0.135 | 10.284 |
| Manufacturing Example 6 | 95.021 | 99.096 | 11.515 | 0.077 | 723.611 |

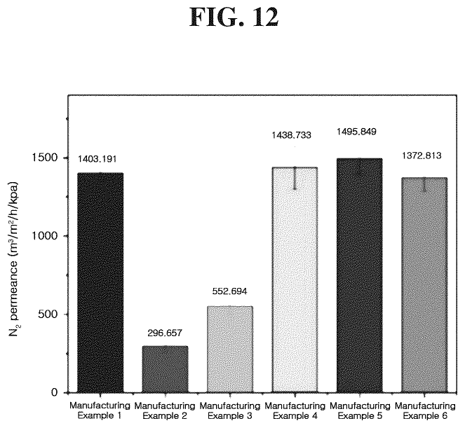

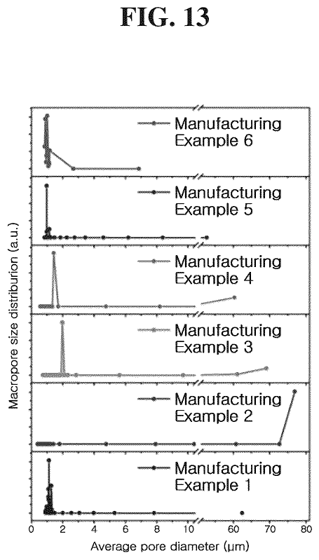

FIG. 12 is graph showing the N₂ permeability for Manufacturing Examples 1 to 6, and FIG. 13 is graphs showing the macropore diameter distribution for Manufacturing Examples 1 to 6.

Referring to FIGS. 12 and 13, Manufacturing Examples 4 and 5 exhibit the highest N₂ permeability. Since Manufacturing Example 4 has a larger average macroporous pore size compared to Manufacturing Example 1, it can be concluded that Manufacture Example 4 forms superior pores.

### Measuring Example 3

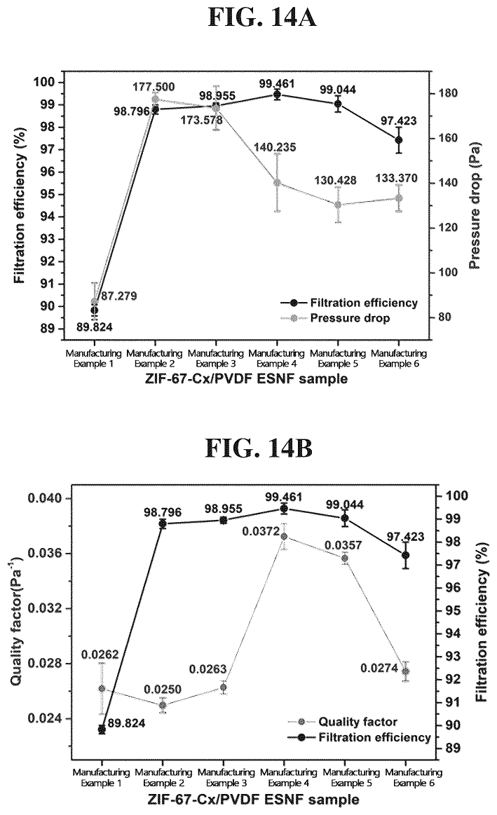

FIG. 14 is graphs measuring the PM (Particulate Matter) filtration efficiency of Manufacturing Examples 1 to 6.

Referring to FIG. 14A and FIG. 14B, the results of the PM0.3 filtration test show that compared to Manufacturing Example 1, where ZIF-67 crystals are not formed, nanofiber hybrid membranes of Manufacturing Examples 2 to 6 exhibit improved 0 values, with Manufacturing Example 4 achieving an excellent 0 value of 99.461%. The decrease in 0 values for Manufacturing Examples 4 to 6 is expected to be due to the diameter of the macro pores. The improvement in 0 values is related to the large surface area and fine porous structure of the ZIF-67 crystallites, which enhance the contact area with PM. Furthermore, nanofiber hybrid membrane of Example 4 exhibits the highest QF (Quality factor) value due to its large specific surface area, excellent pore volume, and optimal necklace-type structure. Therefore, nanofiber hybrid membrane of Manufacturing Example 4 is found to possess the most superior PM filtration performance.

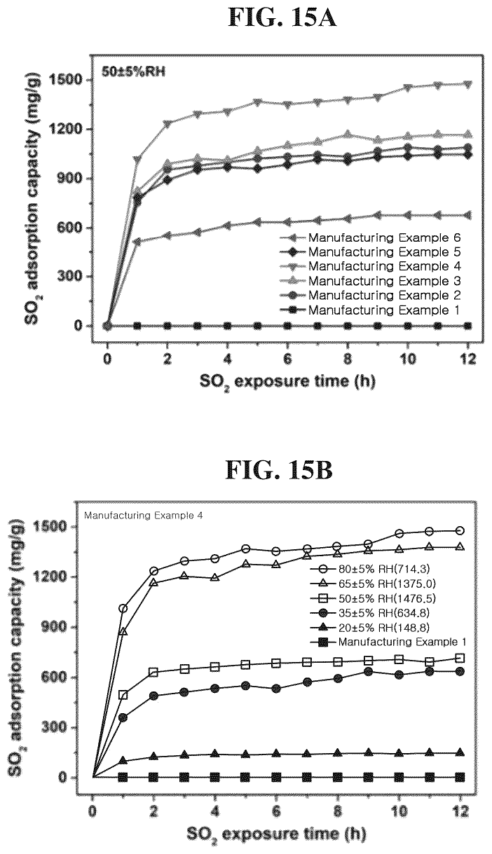

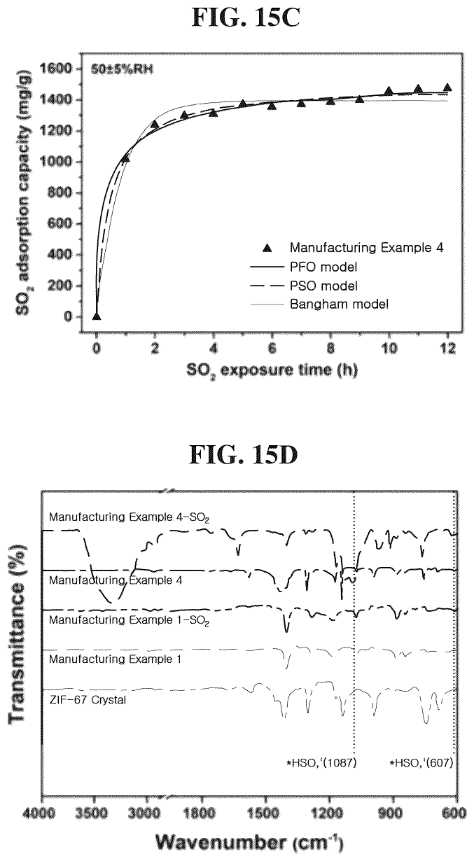

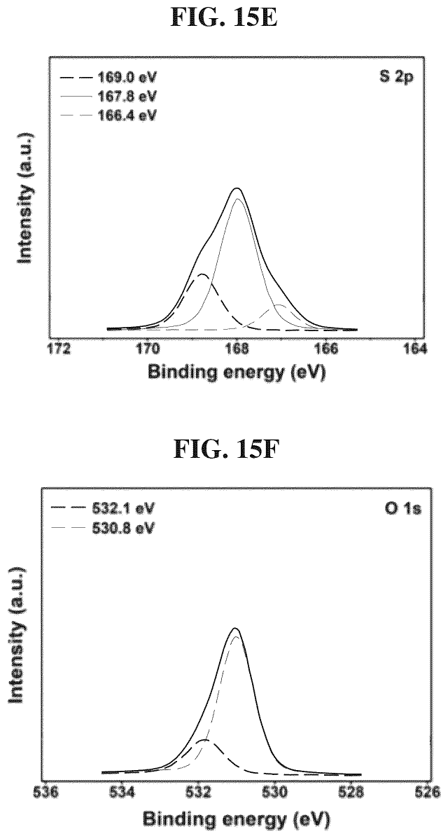

FIG. 15A-FIG. 15F is graphs measuring the SO₂ adsorption performances of Manufacturing Examples 1 to 6.

Referring to FIG. 15A-FIG. 15F, as shown in FIG. 15A, nanofiber hybrid membrane of Manufacturing Example 4 exhibits the most excellent SO₂ adsorption performance under 50±5% RH (Relative Humidity) conditions. This is judged to be due to factors such as the specific surface area, pore volume, and pore type of the aforementioned Manufacturing Example 4. Therefore, when tested under various humidity conditions, nanofiber hybrid membrane of Manufacturing Example 4 exhibits superior SO₂ adsorption capacity compared to Manufacturing Example 1, as shown in FIG. 15B. Thus, under 50±5% RH conditions, the thermodynamic reaction between SO₂ and H₂O is most promoted and SO₂—(H₂O) n complexes are formed, so that the nanofiber hybrid membrane can enhance SO₂ adsorption capacity. Furthermore, to further confirm the adsorption performance and kinetic behavior, three kinetic models are experimentally evaluated and are shown in FIG. 15C. In all three kinetic models, nanofiber hybrid membrane of Manufacturing Example 4 exhibits superior adsorption performance. FIG. 15D shows FT-IR analysis confirming the adsorption mechanisms of Manufacturing Examples 1 and 4. Furthermore, FIG. 15E and FIG. 15F present XPS analysis confirming changes in functional groups and chemical bonds. The peaks in (e) and (f) are expected to result from enhanced chemical adsorption performance of SO₂ by ZIF-67 crystallites due to optimal complexation of H₂O and SO₂ molecules, primarily observed under 50±5% RH conditions.

Therefore, according to the present invention described above, the formation of ZIF-67 crystals in a necklace-type structure on Co²⁺-doped electrospun nanofibers provides excellent chemical stability, enabling long-term reliable air pollution prevention performance and high adsorption capacity for SO₂. Furthermore, it can simultaneously remove particulate matter (PM) and gaseous pollutants such as SO₂, and exhibits excellent filtration performance under various humidity conditions.

Moreover, the necklace-type nanofiber hybrid membrane exhibits excellent hierarchical pore characteristics, including micro-, meso-, and macro-pores, and possesses ultra-stability due to the stable bonding of ZIF-67 crystals to the nanofibers. Moreover, when the nanofiber diameter is 70 nm, ZIF-67 exhibits uniform distribution, causing no structural obstruction to the flow of air or gas molecules. This allows effective exposure to PM and sulfide gases, thereby enhancing air filtration performance.

1. A necklace-shaped nanofiber hybrid membrane comprising:
an electrospun nanofibers; and
a ZIF-67 (Zeolite imidazolate framework-67) formed in necklace-shaped structure surrounding the electrospun nanofibers.

2. The nanofiber hybrid membrane of claim 1, wherein the electrospun nanofibers have an average diameter of 60 nm to 70 nm.

3. The nanofiber hybrid membrane of claim 1, wherein the ZIF-67 crystallite has an average diameter of 250 nm to 1,200 nm.

4. The nanofiber hybrid membrane of claim 3, wherein average diameter of the ZIF-67 crystallite is controlled by introducing amount of Cetyltrimethylammonium bromide (CTAB).

5. The nanofiber hybrid membrane of claim 4, wherein the CTAB is introduced at 0.003 mol/L to 0.3 mol/L.

6. The nanofiber hybrid membrane of claim 1, wherein the necklace-type nanofiber hybrid membrane has ability to simultaneously remove fine dust (Particulate Matter, PM) and SO₂.

7. The nanofiber hybrid membrane of claim 6, wherein the necklace-type nanofiber hybrid membrane has removal rate of 97% or more for particles of 0.3 μm or larger.

8. The nanofiber hybrid membrane of claim 6, wherein the necklace-type nanofiber hybrid membrane has adsorption capacity of 1476.5 mg/g or less for SO₂.

9. The nanofiber hybrid membrane of claim 1, wherein the electrospun nanofibers has polyacrylonitrile (PAN), polyvinylidene fluoride (PVDF), polyvinyl chloride (PVC), or polyethylene terephthalate (PET).

10. A method of manufacturing necklace-type nanofiber hybrid membrane, the method comprising:
a step of electrospinning a polymer solution containing Co²⁺ cations onto a substrate to produce electrospun nanofibers doped with Co²⁺; and
a step of introducing the electrospun nanofibers and a mixed solution containing metal ions and cetyltrimethylammonium bromide (CTAB) into a 2-MIM (2-Methylimidazole) solution and leaving to form ZIF-67 crystallites on the electrospun nanofibers.

11. The method of claim 10, wherein the ZIF-67 crystallites can be controlled in size by interaction between the CTAB and the metal ions.

12. The method of claim 11, wherein average diameter of the ZIF-67 crystallite is 250 nm to 1,200 nm.

13. The method of claim 11, wherein the CTAB is added at 0.003 mol/L to 0.3 mol/L.

14. The method of claim 10, wherein the electrospun nanofibers have an average diameter of 60 nm to 70 nm.

15. The method of claim 10, wherein the necklace-type nanofiber hybrid membrane simultaneously removes particulate matter (PM) and SO₂.

16. The method of claim 15, wherein the necklace-type nanofiber hybrid membrane has a removal rate of 97% or more for particles of PM 0.3 or larger.

17. The method of claim 15, wherein the necklace-type nanofiber hybrid membrane has an adsorption capacity of 1476.5 mg/g or less for SO₂.

18. The method of claim 15, wherein the metal ion is selected from the group consisting of Sc, Ti, V, Cr, Mn, Fe, Co, Ni, Cu, Zn, Y, Zr, Nb, Mo, Tc, Ru, Rh, Pd, Cd, La, W, Os, Ir, Pt, Au, Hg, Sm, Eu, Gd, Tb, Dy, Ho, Al, Ga, In, Ge, Sn, Pb, Li, Na, K, Rb, Cs, Mg, Ca, Sr, and Ba.
